(19) United States
(12) Patent Application Publication
(10) Pub. No.: US 2017/0265502 A1
(43) Pub. Date: Sep. 21, 2017

(54) Methods of Using Composite Materials to Prepare Foods

(71) Applicants: Bradley Farrell, Burbank, CA (US); Jennifer Stitz, North Hollywood, CA (US); Cristi Stitz, Los Angeles, CA (US)

(72) Inventors: Bradley Farrell, Burbank, CA (US); Jennifer Stitz, North Hollywood, CA (US); Cristi Stitz, Los Angeles, CA (US)

(21) Appl. No.: 15/611,764

(22) Filed: Jun. 1, 2017

Related U.S. Application Data
(63) Continuation of application No. 15/611,738, filed on Jun. 1, 2017.
Application No. 15/611,738 is a continuation-in-part of application No. 13/626,811, filed on Sep. 25, 2012.

(51) Int. Cl. A23L 5/20; A23L 5/10

(52) U.S. Cl. CPC A23L 5/273; A23L 5/11; A23V 2002/00

(57) ABSTRACT

A composite material for food contact applications includes an absorbent layer and a non-absorbent layer, the absorbent layer having a textured surface for absorbing and trapping liquids, for example, oil, grease, or water, and the non-absorbent layer having an oleophobic surface that acts as an oil and grease specific liquid barrier. The material further includes one or more lamination layers. The lamination layer acts as a general liquid barrier between the absorbent layer and non-absorbent layer. This additional liquid barrier enhances the liquid repelling effect of the non-absorbent layer to more effectively trap liquids in the absorbent layer, thereby preventing liquids from seeping through the material onto an external surface.

### CROSS REFERENCE TO RELATED APPLICATION(S)

This application is a continuation of U.S. patent application Ser. No. 15/611,738, filed Jun. 1, 2017, and entitled “Composite Materials for Food Contact Applications” which is a continuation-in-part of U.S. patent application Ser. No. 13/626,811, filed Sep. 5, 2012, and entitled “Disposable Pizza-Blotting Composite and Box”, the contents of which are expressly incorporated herein in their entirety.

### TECHNICAL FIELD

In general, the present disclosure relates to composite materials. In particular, composite materials that absorb and trap liquids are described herein.

### BACKGROUND

Many people enjoy “take-out” food as a convenient and economical meal. Many of these foods are messy to eat including fries, pizza, nachos, burritos, tacos, fried rice, stir fry, macaroni and cheese, pasta, fried noodles, fried chicken, hot dogs, burgers, bbq, popcorn, cookies and other baked goods. Liquids including oil, grease, and other organic liquids and water and other polar liquids saturate many take out entrees and drip from conventional food packaging to ruin clothing, upholstery, and the experience of eating.

Despite the mess, many types of take out food are increasing in popularity, for example, pizza. In addition to the mess of pizza grease, high amounts fat, cholesterol, and sodium make eating pizza unhealthy. Accordingly, there exists a long felt, but unresolved need for a composite material to make food packing that removes fats, grease, oils, and other excess nutrients from the surface of meat, cheese, and dough.

Conventional methods of making take out food healthier include using napkins and other paper products to blot excess oil and grease from a food surface before eating. This approach, however, is ineffective because the oil and grease bleeds through the napkin and transfers to the hands of the consumer, thus requiring the use of additional napkins. It is also inefficient because conventional paper products are not optimized to absorb and trap grease. Therefore, others have failed to use conventional methods and materials to minimize the adverse health effects of eating take out foods while also improving the eating experience.

Excess waste is another problem associated with conventional materials used in food contact applications, for example food packaging. Although catchy, colorful, and excessive packaging helps drive sales, it creates unnecessary waste. Worse, many conventional food packaging assemblies are layered and comprise multiple materials, for example, food packaging that comprises a plastic layer enclosed within another paper box outer container. Layering packaging with multiple materials is excessive and makes food packaging more difficult to recycle because of sorting. Accordingly, others have failed to create materials fit for food contact applications that form a single composite material and reduce overall waste.

According to the federal Environmental Protection Agency (EPA), food containers and packaging make up over 23% of all material reaching landfills. To encourage less waste production, the EPA asks businesses, communities, and households to eliminate waste before reusing or recycling. Waste reduction is important component of a sustainable society because it reduces the amount of raw materials extracted in the manufacture of a product and reduces the water, energy, oil and other resources need to manufacture, transport, sell and consume the product.

Due to wasteful and ineffective conventional materials for food contact applications, food packaging comprises most of the litter polluting US roadways, waterways, and beaches. Conventional materials, for example, plastic food packaging are non-compostable, non-biodegradable, and do not readily disintegrate. Instead discarded food packaging accumulates in the environment harming wildlife and disrupting ocean dependent industries including shipping, fishing, tourism, and other ocean dependent industries. Therefore, wasteful and ineffective food packaging materials is a recognized problem.

Conventional materials for food contact applications also contain substances that are harmful to human health. Expanded Polystyrene (EPS, often called STYROFOAM, a product manufactured by DOW CHEMICAL COMPANY) is one harmful material often found in food packaging materials including, for example, takeout containers, drink cups, and plates. EPS is made from non-biodegradable petroleum-based polymer materials and does not break down. Instead, in the presence of sunlight, it photodegrades into small pieces. Additionally, reach shows harmful chemicals leach from EPS containers that contact hot, greasy, or acidic food. All discarded EPS either takes us space in a landfill or ends up polluting land and waterways because it does not naturally compost or biodegrade. In the ocean, EPS breakdowns into its monomer styrene, a human carcinogen. Accordingly there exists a long felt, but unresolved need for materials fit for food packaging applications that do not contain EPS.

Many communities have passed laws banning the use of EPS. In California, 65 ordinances have passed either prohibiting restaurants from using EPS or requiring the use of compostable or recyclable containers. Maine bans the use of EPS for serving individual portions of food or a beverage at a facility or function of the State or of a political subdivision unless containers are recycled. Additionally, communities in Massachusetts, New Jersey, New York, Oregon, Texas, Washington and Washington D.C. have all banned EPS, in food service applications. Lastly, in 2015, New York City passed an ordinance banning all types of ESP food waste and foam packaging peanuts. Accordingly, the presence of EPS in food contact applications is a recognized problem.

Perfluorinated chemicals or PFCs are another class of harmful materials commonly found in conventional materials used in food contact application. The adverse human health impacts of PFCs have been well documented over the last decade. Research shows that even extraordinarily small doses of Teflon, PFOA, and other PFCs can be harmful to human health. For example, a 2006, report from the U. S. Environmental Protection Agency (EPA) Science Advisory Board said PFOA is “likely to be carcinogenic to humans.” Additionally, in 2012, an independent science panel funded by DuPont reported “probable links” between PFOA exposure and testicular and kidney cancer, thyroid disease, pregnancy-induced hypertension and preeclampsia, ulcerative colitis and high cholesterol. More recent research finds that even the smallest doses of PFOA, PFOS, and other PFCs are harmful, because most Americans already have elevated levels of perfluorinated chemicals in their blood stream due to prolonged exposure. Accordingly, there exists a long felt, but unresolved need for materials fit for food contact applications that do not contain PFCs.

Despite the well documented health hazards of PFCs, companies such as DUPONT and 3M have not always been forth coming about the risks of perfluorinated chemicals. In 2001, 3M stopped producing its Scotchgard chemical after admitting to the EPA it withheld decades of damning internal studies on PFCs' health hazards. Additionally, court documents from a West Virginia class action case against DuPont revealed the company had also covered up unfavorable internal studies. In 2006, the EPA fined DuPont a then record $16.5 million and the company agreed to phase out PFOA by 2015. Accordingly, others have failed to create materials fit for food contact applications that do not contain PFCs.

In an effort to protect consumers, FDA banned PFOA from food packaging. Other PFC substances, for example, TEFLON (perfluorooctanoic acid or PFOA) were phased out of food contact applications after being linked to cancer and reproductive and developmental harm. The agency, however, continues to allow the use of other PFCs with slightly different chemical structures in food packaging applications. The FDA has approved 20 types of PFCs for coating paper and paperboard used to serve food. Despite regulatory approval, concerns about the health impacts of PFCs persist due to insufficient testing, particularly of new PFC compounds. DuPont even filed documents with the EPA, reporting GenX, one of their next-generation PFC chemicals used to coat food packaging, could pose a “substantial risk of injury,” including cancerous tumors in the pancreas and testicles, liver damage, kidney disease and reproductive harm.

Other companies have tried to avoid materials containing PFCs. BURGER KING, for example, stopped using paper coated with fluorinated chemicals in 2002. MCDONALD'S also pledged to move away from PFOA coatings. On the production side, the manufacture of PFOA by DUPONT and seven other companies in the U.S. ended ahead of schedule in 2011. Additionally, the FDA officially banned the use of three PFOA-based chemicals in food packaging in January 2016. The FDA also added two new PFOS-based chemicals to its ban in November 2016 after receiving a petition from 3M indicating that production ended almost 15 years earlier. Therefore, the presence of PFCs in materials used for food contact applications is a recognized problem.

Despite the FDA's ban, tests indicate many conventional materials used in food contact applications, for example, food packaging used by some fast food outlets, are still coated with grease resistant PFOA, PFOS, or related chemicals. Alternatively, many chains are using papers coated with next-generation PFCs hoping they are “safer”. In 2014 and 2015, tests undertaken by non-profit research organizations, along with federal and state regulatory, and academic institutions studied wrappers for sandwiches and burritos, bags for fried foods, chips, and pastries, pizza and chicken boxes, and other paper and paperboard items used to serve food from twenty seven fast food chains and other restaurants in the U.S. The study revealed that of the three hundred twenty seven samples collected between 2014 and 2015 from fast food outlets in Boston, San Francisco, Seattle, Wash., D.C., and Grand Rapids (MI), 40 percent tested positive for fluorine, an indicator of PFCs. Further tests on smaller numbers of samples found the overwhelming majority of food packaging contains PFCs. More specifically some samples were found to have traces of PFOA, the former Teflon chemical. In these studies, PFCs showed up in food packaging used at many of the most popular and well-known fast food restaurants, including. ARBY'S, BURGER KING, CHIC-FIL-A, DAIRY QUEEN, DUNKIN DONUTS, JIMMY JOHNS, PANERA, STARBUCKS, QUIZNO'S, and TACO BELL. Accordingly, others have failed to create materials for food contact applications that do not contain PFCs.

PFC-based coatings on food packaging materials present a serious health risk because the hot, fatty foods served in PFC packaging soak up the chemicals in contact with the food. By eating food served in PFC packaging, consumers often consume PFCs and other chemicals. A 2008 FDA study found that “fluorochemical paper additives do migrate to food during package use,” and oil and grease “can significantly enhance migration of a fluorochemical from paper.” Additionally, a 2009 EPA study identified food contact paper as a key pathway for PFCs to enter the body. Therefore, there exists a long felt, but unresolved need for materials for food contact applications that contain no PFCs.

Oil and grease contamination is another problem associated with conventional food preparation techniques that use conventional materials for food contact applications including cooking. Contamination from oil and grease is one of the biggest threats to clean municipal water in the United States. To maintain clean water, the National Pretreatment Program (NPP) implements the Clean Water Act requirements to control pollution in Publically Owned Treatment Works (POTWs). As part of the NPP, the EPA requires State and local governments to control pollutants that complicate POTW treatment processes or contaminate POTW sewage sludge. These requirements typically mandate eliminating the discharge of Fats, Oils, and Grease (FOG) from food service establishments (FSE). More specifically, the NPP regulations prohibit “solid or viscous pollutants in amounts which will cause obstruction” in the POTW and its collection system. The EPA's Report to Congress on combined sewer overflows (CSOs) and sanitary sewer overflows (SSOs) identified that “grease from restaurants, homes, and industrial sources are the most common cause (47%) of reported blockages”. FOG is a big problem for municipal water infrastructure because it “solidifies, reduces conveyance capacity, and blocks flow.” The annual production of collected grease trap waste and uncollected grease entering sewage treatment plants can be significant and ranges from 800 to 17,000 pounds/year per restaurant. Accordingly, FOG contamination of municipal water is a recognized problem.

In response to the overwhelming number of FOG caused blockages identified in CSO/SSO Report to Congress, a growing number of control authorities are establishing and enforcing more FOG regulatory measures to control FOG discharge by FSEs. Federal, State, and local governments are employing regulatory methods to encourage FSEs to adopt best management practices. These regulatory methods include frequent inspections, periodic grease pumping, stiff penalties, and even criminal citations for violators, along with ‘strong waste’ monthly surcharges added to restaurant sewer bills. Reported surcharges range from $100 to as high as $700 or more. In light of this harsh regulatory environment, FOG discharge is a serious problem for any restaurant that deep fries food or prepares food containing high concentrations of FOG. Accordingly, there is long felt, but unresolved need for a material used in food contact applications, including cooking, that absorbs FOG and prevents FOG contaminates from reaching the clean water supply.

Using conventional materials in food contact applications also contaminations recycling and composting streams. Recycling is an important component of a sustainable system of waste disposal with some state and local recycling operations diverting as much as 25%-90%+ of waste away from landfills. Food packaging materials, for example, pizza delivery boxes, made from recyclable materials, including corrugated cardboard, become contaminated when fats, oils, and grease from cooked meat, cheese, and dough are absorbed into the material. The oily substances are incompatible with the water based process of making pulp from recycled paper and thereby cause otherwise recycle food packaging materials to become landfill waste. Due to the costly problems associated with grease contamination of pulp including paper plant shutdowns for equipment maintenance and cleaning, the vast majority of food packaging is not recycled. Accordingly, FOG contamination in the recycling stream is a recognized problem and there exists a long felt, but unresolved need for a composite material fit for food contact applications that protects recyclable food packaging materials from FOG.

It is estimated that up to 20% of all municipal solid waste in the US is food waste. Composting currently offers the best opportunity to divert food waste away from landfills because alternatives including animal feed and bio-digestion are high regulated and relatively unproven at scale. Unfortunately, as with recycling, contamination is the largest force undermining current composting efforts. Incorporating FOG and other materials that do not break down in the composting process increases costs and decreases the quality of the end product, humus, the organic component of soil. Additionally, food packaging contaminates in the composting stream, require many commercial composting operations to invest in state-of-the-art depackaging and screening equipment before they can accept food waste. Accordingly, there exists a long felt, but unresolved need for a composite material used in food contact applications that is compostable in large-scale composting operations.

Regulations have been in enacted in many jurisdictions to encourage food waste diversion through composting. For example, state governments in Connecticut, Massachusetts and Vermont have laws prohibiting landfill disposal of food waste from large commercial food waste generators. Similarly, municipal governments in New York City and Austin, Tex. have programs for diverting large-scale food scraps from hotels, hospitals, and other large generators. To divert residential waste, these jurisdictions offer curbside organic composting. Other regulatory schemes require large food waste generators, such as restaurants and grocery stores, to separate and divert food waste from trash. For example, San Francisco and Seattle both have mandatory requirements for food waste diversion for all generators including residential and commercial establishments. An alternative approach incentivizes waste diversion. In San Diego and Charleston County, South Carolina, separating food waste from other trash significantly reduces the tipping fee for waste collection.

Despite increased regulation and the environmental and practical benefits of composting food waste including less crowded landfills, lower overall trash production, and cheaper trash disposal, only about 10% of commercial establishments currently process food waste. BioCycle Magazine, the premier resource for compost and organics news, reported that of the approximately 5,000 compost operations across the country, only about 500 of them are accepting food waste. The greatest opportunity for expansion of food waste composting, therefore, lies in large-scale operations. Accordingly, others have failed to develop and implement compostable materials for food contact applications in order to establish composting as an effective technique for diverting food waste.

Greenwashing and other methods of disseminating disinformation about a product to present an environmentally responsible public image is a common and effective form of false advertising associated with environmentally friendly products. Clear testable standards can reduce the impact of greenwashing by making composting practices more transparent and easier to understand. There are many words to describe products that break down under various conditions, for example, compostable, biodegradable, degradable, and photogradable. As more materials for food contact applications become marketed as recyclable, biodegradable, compostable, bio-digestible, and/or photogradable, standards for these materials must be clear and easily enforced to avoid contamination across the spectrum of disposal streams. Accordingly, there is a need for a compostable food packaging material that meets internationally accepted composting standards, for example, Europe's EN 13432 found in European Directive 94/62/EC, the American Society for Testing and Materials D6868, and the Australian Standard AS4736-2006.

Obesity stemming from overconsumption of take out foods and other foods high in fat, cholesterol, and sodium is one of the biggest public health problems in the United States. According to the Center for Disease Control, more than one-third of adults (36.5%) and 17% of youth in the United States are obese. The World Health Organization (WHO) reports that obesity is associated with a “greatly increased risk” of diabetes, gall bladder disease, hypertension, dyslipidemia, insulin resistance, breathlessness, and sleep apnea; a “moderately increased risk” of coronary heart diseases, osteoarthritis, hyperuricemia, and gout; and “slightly increased risk” of cancers, reproductive hormone abnormalities, polycystic ovary syndrome, impaired fertility, low back pain, increased anesthetic risk, and fetal defects as a result of maternal obesity. According to a WHO report obesity is on the rise in the US and worldwide with the number of obese adults now estimated to be over 300 million. This represents a 33% increase from 200 million in 1995.

Unhealthy dietary habits leading to overconsumption of fat, cholesterol, and sodium is a leading cause of the growing global obesity epidemic. According to studies conducted by the National Institute of Health (NIH), overconsumption of food rich in fat leads to weight gain because fat has low satiety properties and high caloric density. Epidemiological evidence uncovered by the NIH suggests a high-fat diet promotes the development of obesity and indicates a direct relationship between the amount of dietary fat and the degree of obesity. The American Journal of Clinical Nutrition has also published evidence indicating a causal relationship between dietary fat intake and obesity. This work states there is ample research from animal and clinical studies, from controlled trials, and from epidemiologic and ecologic analyses to provide strong evidence that dietary fat plays a leading role in the development and treatment of obesity. Accordingly, a high-fat diet resulting from overconsumption of take out foods is a well recognized problem.

Results from 28 clinical trials studying the effect of reducing the amount of energy from fat in the diet further confirm lowering dietary fat is a leading treatment for obesity. Many publications including a recent article in the journal of the American Dietetic Association Data demonstrate the positive impact absorbing unhealthy nutrients from take out foods has on dietary fat. The paper includes data, complied by Iowa State University from the U. S. Department of Agriculture's Nutrient Database, suggesting fat from meat contributes a significant portion of the calories and fat in many unhealthy diets. Iowa State University's Dr. Garden-Robinson notes that draining fat from ground beef and other meats after cooking significantly reduces fat and calorie content. Therefore, there is a long felt, but unresolved need for materials used in food contact applications that absorb FOG from food surfaces.

In addition to high dietary fat, elevated levels of dietary sodium can cause serious health concerns. Harvard University's School of Public Health reports kidneys in most people with high sodium diets have trouble processing excess sodium in the bloodstream. As unfiltered sodium accumulates, the body holds onto excess water to dilute the sodium. This increases the amount of fluid surrounding cells and the volume of blood in the bloodstream. Increased blood volume puts more pressure on blood vessels while making it more difficult for the heart to circulate blood. Over time, the extra work and pressure stiffens blood vessels and accelerates heart aging. Deteriorating blood vessels and cardiac tissue, in turn, leads to high blood pressure, heart attack, stroke, and heart failure. As the leading cause of heart disease, high blood pressure is a serious medical condition. It accounts for two-thirds of all strokes and half of all cases of cardiac disease. There is also evidence suggesting that high amounts of dietary salt damages the heart, aorta, and kidneys independent of increasing blood pressure and volume.

A recent study in Archives of Internal Medicine provides more evidence that high salt diets have negative effects on health. In this study, people with the highest sodium intakes had a 20 percent higher risk of death from any cause than people with the lowest sodium intakes. Besides contributing to high blood pressure, consuming high amounts of sodium can also lead to stroke, heart disease, and heart failure. Research also shows that reducing sodium lowers cardiovascular disease and death rates over the long term. Research also shows that higher intake of salt, sodium, or salty foods is linked to an increase in stomach cancer. The World Cancer Research Fund and American Institute for Cancer Research concluded that salt, as well as salted and salty foods, are a “probable cause of stomach cancer.” A diet high in sodium is also linked to osteoporosis, the bone-thinning disease. The amount of calcium that your body loses via urination increases with the amount of salt you eat. If calcium is in short supply in the blood, it can be leached out of the bones. Some studies have shown that reducing salt intake causes a positive calcium balance, suggesting that reducing salt intake could slow the loss of calcium from bone that occurs with aging. Accordingly, excess sodium in the bloodstream resulting from elevated dietary sodium is a well recognized problem. Advanced food packaging materials that make food healthier by absorbing unhealthy substances are one solution to this problem. Therefore, there exists a long felt, but unresolved need for materials used in food contact applications that absorb sodium from food surfaces.

In addition to elevated levels of FOG and sodium, high dietary cholesterol can cause serious health problems. There are two types of cholesterol, one considered “good” and the other considered “bad”. High-density lipoprotein (HDL), or “good,” cholesterol picks up excess cholesterol and takes it back to ones liver. Low-density lipoprotein (LDL), or “bad,” cholesterol transports cholesterol particles throughout your body. LDL cholesterol builds up in the walls of your arteries, making them hard and narrow. Many factors determine a person's cholesterol levels including genetic makeup, inactivity, obesity, an unhealthy diet, diabetes and smoking.

According to the Centers for Disease Control and Prevention, 73.5 million adults (31.7%) in the United States have high low-density lipoprotein (LDL), or “bad,” cholesterol. Fewer than 1 out of every 3 adults (29.5%) with high LDL cholesterol has the condition under control and less than half (48.1%) of adults with high LDL cholesterol are getting treatment to lower their levels. People with high total cholesterol have approximately twice the risk for heart disease as people with ideal levels. Nearly 31 million adult Americans have a total cholesterol level greater than 240 mg/dL.

According to the Mayo Clinic, high cholesterol can cause atherosclerosis, a dangerous accumulation of cholesterol and other deposits on the walls of your arteries. Once coronary arteries that supply the heart with blood become affected by cholesterol buildup, chest pain and other symptoms of coronary artery disease may occur. This buildup often combines with calcium and other bioavailable substances to form plaques, which can tear or rupture arteries and other blood vessels. After tearing, a blood clot often develops at the plaque-rupture site. This clot can block the flow of blood or breaking free and plug an artery downstream. Such blockages are very dangerous because they frequently stop blood flow to part of the heart causing heart attacks. Similar conditions in the brain, lead to blocked blood flow to neural tissue and stroke. Accordingly, cholesterol accumulation on artery walls resulting from elevated dietary fat and cholesterol is a well recognized problem.

Despite the well-documented danger of high fat, sodium, and cholesterol diets, many unhealthy food options exist. These take out food options are staples of many diets because fresh food such as fruits and vegetables are less convenient, more expensive and less accessible. Since eliminating take out food is not a realistic option for many people, a multi-billion dollar pharmaceutical industry has been developed to help people many the symptoms associated with maintaining an unhealthy diet. For example, many prescription drugs help lower cholesterol and treat other symptoms of obesity including diabetes, high blood pressure, and heart disease. Although many of these drugs are temporarily effective there are often significant costs and potential side effects associated with this path of treatment. Therefore, there exists a long felt, but unresolved need for materials used in food contact applications that absorb fat, sodium, and cholesterol from food surfaces.

### SUMMARY OF INVENTION

The invention included herein comprises a composite material for food contact applications. The composite material includes an absorbent layer and a non-absorbent layer, the absorbent layer having an oleophilic surface for absorbing and trapping liquids, for example, oil, grease, or water, and the non-absorbent layer having an oleophobic surface that acts as an oil and grease specific liquid barrier. The material further includes one or more lamination layers. The lamination layer acts as a general liquid barrier between the absorbent layer and non-absorbent layer. This additional liquid barriers enhances the liquid repelling effect of the non-absorbent layer to more effectively trap liquids in the absorbent layer, thereby preventing liquids from seeping through the material onto an external surface.

The composite material may be used as a food packing material that absorbs fat, calories, cholesterol, sodium, and other substances from the surface of greasy take out foods. Food packing made from the material also prevents contamination in the recycling stream by preventing FOG and other liquids absorbed from a food surface from contacting food packaging assembles made from recyclable materials, for example, corrugated cardboard. The material is also flourine-free, EPS free, non-biotoxic, and safe for food contact applications. As used herein, “fluorine free” refers to materials that are composed of raw materials and ingredients that are free from perfluorooctanoic acid (PFOA, CAS 335-67-1), ammonium perfluorooctanoate (CAS 3825-26-1), perfluorooctane sulfuric acid (PFOS, CAS 1763-23-1), potassium perfluorooctane sulfonate (CAS 2795-39-3), ammonium perfluorooctane sulfonate (CAS 29081-56-9), lithium perfluorooctane sulfonate (CAS 29457-72-5), diethanolamine (DEA) salt (CAS 70225-39-5), perfluorooctanesulfonyl fluoride (CAS 307-35-7), perfluorinated carboxylic acids (PFCAs), for example, perfluorononanoic acid (CAS 375-95-1), perfluorodecanoic acid (CAS 335-76-2), perfluoroundecanoic acid (CAS 4234-23-5), perfluoroundecanoic acid (CAS 307-55-1), perfluorododecanoic acid (CAS 307-55-1), perfluorotridecanoic acid (CAS 72629-94-8), perfluorotetradecanoic acid (CAS 376-06-7), hexacosafluoro-13-(trifluoromethyl)tetradecanoic acid (CAS 18024-09-4), perfluorohexadecanoic acid (CAS 67905-19-5), perfluorooctadecanoic acid (CAS 16517-11-6), and perchlorate (CAS 14797-73-0). As used herein, “non-bioxtoxic” refers to materials that are composed of raw materials and ingredients that are free from heavy metals including Arsenic, Barium, Cadmium, Chromium, Lead, Mercury, Selenium, and Silver, and substances listed as carcinogens by the Occupational Safety and Heath Administration (OSHA). As used herein, “safe for food contact applications” refers to materials that comply with the Federal Food and Drug Cosmetic Act under applicable sections and provisions of Title 21 CFR including parts 175: Adhesives and Components of Coatings, 176: Indirect Food Additives: Paper and Paperboard Components, and 178: Adjuvants and Production Aids or the FCN Program. As used herein, “food contact applications” refers to producing, manufacturing, packaging, processing, preparing, treating, cooking, packing, transporting, or holding foods.

In at least one example, the material is 100% compostable according to international composting standards. As used herein, “degradable” refers to materials that disintegrate over a number of years, but do not have a defined amount of time or conditions under which they degrade. As used herein, “biodegradable” refers to materials that break down through processing by a naturally-occurring organism, for example, a bacteria, fungi, or algae. Biodegradable does not require the material to break down in a certain period of time, nor under the conditions found in the composting process. Degradable and biodegradable materials do not meet all composting standards therefore contaminate the composting stream. Therefore, it is important for food service establishments and consumers to easily recognize the difference between degradable and biodegradable materials and compostable materials in order to avoid introducing contaminants into the compost stream. As used herein, “compostable” refers to materials that contain no heavy metal content, disintegrate in less than 84 days and completely biodegrade in less than 180 days. The European Standardization Committee's (CEN) EN 13432 lays down criteria for what can or cannot be described as compostable and what can be called biodegradable. The US Standards ASTM D6400-99 and ASTM D6868-11 sets out similar standards. European Standard EN 13432 is the basis of the International Standards Organization (ISO) Standard ISO14855. These standards ensure compostable materials break down in industrial composting conditions. Materials that meet either the European or US Standard will break down effectively in virtually every commercial composting system. The Australian Standard AS4736-2006 is closely based on EN 13432, with the exception of a worm eco-toxicity test not required by the other standards. International composing standards require compostable materials to meet the following criteria:

“Biodegradability”—measured by metabolic conversion of the material to carbon dioxide to at least 90% in less than six months. (90% is used to account for sampling error, not to allow for non-biodegradable material).

“Disintegrability”—there should be fragmentation below a certain size with no visible contamination (screened at 2 mm after 180 days with less than 10% original mass)

Absence of negative effects on the final compost using a plant grow test and physical/chemical analyses

Chemical/physical parameters identical to compost without the test materials after degradation—pH, salinity, volatile solids, Nitrogen, Phosphorous, Magnesium and Potassium.

Composite materials of this invention are configured for use as food packaging and cooking materials in restaurants, homes, fast-food kitchens, food trucks, event concessions, and other food services. When used as cooking materials, for example, cookware liners, the composite material helps FSEs keep FOG discharge within the EPA reported range of local limits (50 mg/L to 450 mg/L). By soaking up FOG from foods containing meats, dairy, and other FOG producing ingredients before, during, and after the cooking process, the material can be used by FSE to reduce FOG discharge and eliminate the threat of FOG caused sewer blockages and overflows. In one example, food packaging made from the composite material soaks up FOG while the food is in storage. In another example, baking sheet covers and other cookware liners made from the material absorb grease as it is secreted during the cooking process. In another preferred embodiment, the composite material is applied to cooked food either directly or through integrations with an existing food packaging assembly such as pizza boxes, chip and popcorn bags, and sandwich wrappers to absorb grease after cooking. Using the composite material in all food contact applications, FSEs preparing greasy take out foods such as pizza, hamburgers, tater tots and French fries, corn dogs, doughnuts, or biscuits can eliminate FOG discharge and dispose FOG in a sustainable way.

The composite material may also be incorporated into conventional food packaging assembles to reduce FOG contamination of recycling and composting streams. Once FOG and other liquids are absorbed in the absorbent layer, the lamination layer and non-absorbent layers act as liquid barriers to prevent FOG from seeping through the composite material and into food packaging. These structures for absorbing and trapping grease allow the composite material to protect recyclable food packaging materials, for example, pizza boxes and take out food containers, from excess FOG in greasy take out foods. Accordingly, communities, food services, and other organizations seeking to divert waste away from landfills through recycling can use to composite material to absorb excess FOG and prevent FOG contamination of recyclable food packaging materials.

Similarly, compostable embodiments of the composite material makes food waste diversion through composting easier by eliminating the need to desegregate food packaging from food waste. In at least one example, the composite material is incorporated into a compostable food packaging assembly that completely breaks down under industrial composting conditions. The compostable characteristics of the composite material have been proven using laboratory precision and perfected under actual conditions through test kitchen and actual biodegradation experiments. The composite material contains no volatile matter or heavy metals and is fluorine free, non-biotoxic, and safe for food contact applications. The material also has a flash point greater than 400° F. and is safe for high temperature cooking applications.

Embodiments of the composite material described herein, may have their characteristics and properties certified by at least one of federal, state, and local governments, environmental organizations, and other third parties. Environmental claims, including the composite material's ability to reduce chemical and FOG discharge and FSE water consumption by alleviating dishwashing can be certified by the federal or state FDA. This certification distinguishes products made from the composite material from conventional products having a bigger FOG footprint in order to educate the market and encourage firms to competitively develop sustainable food packaging and cooking technologies. Specifically, the EPA may certify an embodiment of the composite material removes an defined amount or range of FOG from the water supply in accordance with the Clean Water Act, the National Pretreatment Program (NPP), a Federal Final Rule (FR), or a provision of the Code of Federal Regulations (CFR).

Additionally, governments and other third party organizations may promulgate measures requiring FSEs, food packaging manufactures, and paper companies to use or provide food packaging and cooking materials that reduce FOG discharge, for example, materials for food contact applications made from the composite material described herein. Such measures would promote better management of FOG discharge by FSEs that frequently cook meats, cheeses, baked goods, and other dishes with butter, oil, or shortening.

Embodiments of the composite material may also be certified as a 100% compostable material by a third party organization. Many organizations can certify the compostable properties of materials including government organizations, for example, US state and federal agencies, including the Food and Drug Administration (FDA), Environmental Protection Agency (EPA), Federal Trade Commission (FTC), and the Department of Agriculture (USDA). Third party organizations such as the American Society for Testing and Materials (ASTM), the U.S. Composting Council (USCC) Certification Commission, the Biodegradable Products Institute (BPI), DIN CERTO (a German based company), Vincotte (a Belgium based organization), and Cedar Grove Composting (a Seattle, Wash. based company).

To convey the compostable certification to consumers encountering the composite material in the marketplace, embodiments of the composite material may be marked with a logo or certification seal used by certifying third party. The material can also be advertised and marketed as certified compostable through product packaging, press releases, and commercials. Additionally, print and web publications such as Planet Natural and BioCycle magazine can also publish a list of certified compostable materials. Enforcement organizations such as the FTC, in the US, are in place to verify products marked—and marketed as—certified compostable meet the requirements of the certification. Currently, under the FTC's current legal framework for combating unfair and deceptive trade practices, if a product is tested and does not conform to the certification, the product can be pulled from the market and the company selling the product can face legal damages as well as bare the cost of creating and operating court ordered internal quality control measures. In addition to compostability, other properties of the composite material described herein may be certified by a government authority or third party organization. These properties include the composite material's safety features, for example, the material's EPS, fluoride, and heavy metal free composition, the material's ability to reduce recycling stream and composting stream contamination, the material's ability to reduce water use by eliminating water needed to clean FOG from baking sheets, skillets, grills, and other cookware, and the material's ability to reduce water pollution by eliminating FOG discharge from kitchen operations through absorbing FOG during the cooking process.

Embodiments of the composite material described herein make take out food healthier by absorbing fat, sodium and cholesterol from the surface of take out food during preparation, transportation, and consumption. By soaking up excess nutrients from foods like meat, chicken, and fried foods, for example, fried cheese, fried vegetables, French fries, onion rings, and corn dogs, the material provides a cost-effective and efficient way of reducing the negative health impacts of convenient take out foods supplied by fast food restaurants, sit down restaurants, pubs, cafeterias, food trucks, and other food service operations at fairs, sporting events and festivals.

To convey the health effects and nutritional impact of the composite material, to consumers in the marketplace, the composite material may be certified by third party organizations including the federal FDA. In one example, the estimated amount of nutrients absorbed by the composite material is listed in the food's nutrition facts and nutritional labeling in compliance with Chapter 7 of the federal FDA's food labeling guide in accordance with the Food, Drug, and Cosmetic Act. Health claims relating to the performance of embodiments of the composite material including, for example, “heart healthy”, “lower fat”, “lower sodium”, “lower cholesterol”, “healthier food”, and corresponding logos may also be certified by a third party organization. In one example, the third party organization is the federal FDA and the certification is granted in compliance with Chapter 8 of the federal FDA's food labeling guide in accordance with the Food, Drug, and Cosmetic Act. Health claims in this example may comply with the criteria set forth in a Federal Statute, Final Rule (FR), or provision of the Code of Federal Regulations (CFR), for example, 21 CFR 101.9(k)(l), 101.14(c)-(d), and 21 CFR 101.70.

In one example, the absorbent layer, the non-absorbent layer, and the one ore more lamination layers are joined to form a composite having a basis weight between 5 lb and 55 lb.

In one example, the composite material is dimensioned to cover all or a substantial portion of a pizza's surface. In this example, the composite material may be fixed to a pizza box assembly with the non-absorbent layer is secured to the interior top or bottom surface of the pizza box. In this embodiment, the oil and grease-blotting composite is positioned against the bottom surface of a pizza box to absorb oil and grease from below, leaving the upper surface of the pizza undisturbed and appetizing. It has been found that positioning the composite below the pizza in this position, with the absorbent side up, is highly effective in extracting oil and grease from the pizza. Furthermore, the non-absorbent layer at the bottom of the composite substantially prevents oil and grease from reaching the cardboard of the box, preserving the ability of the box to be recycled after use. Alternatively, oil and grease blotting composite layers may be placed both above and below the pizza to extract oil and grease from both directions.

In a further embodiment, the non-absorbent layer may be an insulating oil and grease resistant paper or metallic foil that reflects heat back toward the pizza or other food item, thereby minimizing the dissipation of heat through the box.

More specifically, in an embodiment, the invention comprises a disposable food-blotting composite having an absorbent layer comprising a physiologically safe cellulosic fibrous mat material with at least one oleophilic surface; a flexible, non-absorbent layer underlying the absorbent layer, the non-absorbent layer including a malleable polymeric material having at least one oleophobic surface; one or more flexible lamination layers or coatings having at least one oleophobic surface, the flexible lamination layer for covering at least one surface of the absorbent layer, the non-absorbent layer or both; wherein the absorbent layer, the non-absorbent layer, and one or more lamination layers are joined to one another to form a composite and wherein the composite is dimensioned to cover a substantial portion of a surface of an item of food with the absorbent layer configured to contact the item of food in use.

Alternatively, a pizza box assembly according to the invention may include a pizza box having a top and an inner receptacle covered by the top; a pizza-blotting composite including an absorbent layer comprising a physiologically safe material having at least one oleophilic surface; a flexible, non-absorbent layer containing a malleable material having at least one oleophobic surface; and one or more flexible lamination layers or coatings having at least one oleophobic surface, the flexible lamination layer for covering at least one surface of the absorbent layer, the non-absorbent layer or both; wherein the absorbent layer, the non-absorbent layer, and the at least one lamination layer are joined to one another to form a composite and wherein the composite is dimensioned to cover a substantial portion of a surface of a pizza with the absorbent layer facing the pizza in use, and wherein the non-absorbent layer is attached to the bottom interior surface of the pizza box.

Alternatively, the composite material may be dimensioned to fit, converted into, or otherwise incorporated into other food packaging assemblies, for example, bags, napkins, trays, boxes, plates, bowls, cups, and other dishes, wrappers, sheets, liners, or cartoons. In another example, the composite material may be used as an absorbent pad for cleaning up pet experiment, for example, urine and feces. Absorbent pads comprising the composite material may also be used for protecting machinery, for example, car and motorcycle lifts, from oily substances, for example, motor oil, brake fluid, and engine lubricant. The composite material may also be used as a cleaning pad for cleaning oily substances from tables, countertops, workstations, car interiors, and other surfaces.

Alternatively, the composite material may be infused with seeds, fertilizer and other plant nutrients. In this example, the non-absorbent layer may be water resistant in order to form a water barrier between the planted seeds and an external surface. This configuration seals water inside the material so that it can be absorbed by the seeds for germination and plant growth. In this example, the composite material is compostable and safe for in-ground planting.

Enclosing seeds in the composite material removes the need for farming plastic to control the diffusion of irrigation water and/or fumigation gases. It also prevents birds from eating the seeds and keeps plants warm in cold weather.

A method of the invention for extracting oil and grease from a food item after cooking includes i) obtaining a composite sheet having an absorbent layer of a physiologically safe material having at least one oleophilic surface; a flexible, non-absorbent layer underlying the absorbent layer, the non-absorbent layer including a malleable material having at least one oleophobic surface; and one or more flexible lamination layers or coatings having at least one oleophobic surface, the flexible lamination layer for covering at least one surface of the absorbent layer, the non-absorbent layer or both; wherein the absorbent layer, the non-absorbent layer, and the at least one lamination layer are joined to one another to form a composite and wherein the composite is dimensioned to cover a substantial portion of a surface of an item of food with the absorbent layer facing the item of food; ii) placing the composite sheet above, below, or both above and below the item of food after it is cooked; and iii) discarding the composite sheet after oil and grease from the food item have been absorbed by the absorbent layer.

An alternative method of using the composite material to absorb nutrients from a food surface includes: i) obtain a take out food, ii) within 5 minutes of purchasing the food, insert the composite material between the food packaging holding the food and at least one food surface so that the pad is between the food surface and the food packaging, iii) close the food packaging and weight 30 minutes, iv) remove the first composite material pad and apply a second pad to the food surface by pressing down lightly to assure contact between the food and the composite material, v) remove both pads after 2 minutes of contact by the second pad, vi) remove any loose material from the pads, and vii) dispose of the two pads of composite material.

The composite material may be configured to absorb grease from food, cooking oil, hydrocarbons, lubricants, or any other type of oil substance. The composite paper may also be configured to be recyclable, compostable, biodegradable, or otherwise configured for sustainable use. By combining the oil resistance necessary to prevent oil from spoiling otherwise recyclable food packaging with the disposal advantages of paper, for example, compostability and biodegradably, the composite paper described herein offers a comprehensive and sustainable solution to cardboard spoilage.

### BRIEF DESCRIPTION OF THE DRAWINGS

A full and complete description of the present storage system is provided herein with reference to the appended figures, in which:

FIG. 1 is a top plan view of a pizza-blotting composite, according to a first aspect herein;

FIG. 2 is a cross-sectional view of the pizza-blotting composite of FIG. 1, as taken along line II-II of FIG. 1;

FIG. 3 is a perspective view of a pizza box assembly containing the pizza-blotting composite of FIG. 1, according to another aspect provided herein;

FIG. 4 is a perspective view, partially broken away, of a pizza box assembly containing the pizza-blotting composite of FIG. 1, according to yet another aspect provided herein; and

FIG. 5 is a perspective view, partially broken away, of a pouch-like container for storing the composite and distributing it to consumers with the purchase of a food item, such as pizza.

FIG. 6 is a picture of a baking sheet that was used to cook bacon at 450° F. The darker color on the sustainable paper composite inside a pizza box assembly after it has absorbed excess nutrients from the bottom of a cooked pizza. The wicking effect of the sustainable composite is clearly visible from the photograph.

### DETAILED DESCRIPTION

Reference is now made to the drawings for illustration of various embodiments of the composite material and food packaging assembly. While the discussions herein refers to a round composite configured to fit inside a pizza box assembly, it should be understood that the material may be made in any shape, as needs dictate, for example, to accommodate rectangular pizzas or to cover the top or bottom of a square or rectangular pizza box. The composite material may also be integrated into any type of food packaging, for example, bags, trays, boxes, plates and other dishes, wrappers, foils, or cartoons. Further, although the discussion herein focuses on absorbing oil from pizza surfaces, it should be understood that the material described herein is equally well suited for absorbing oil and/or grease from other dishes, such as lasagna, fries, nachos, burritos, tacos, fried rice, stir fry, macaroni and cheese, pasta, fried noodles, fried chicken, hot dogs, burgers, bbq, popcorn, and other messy foods.

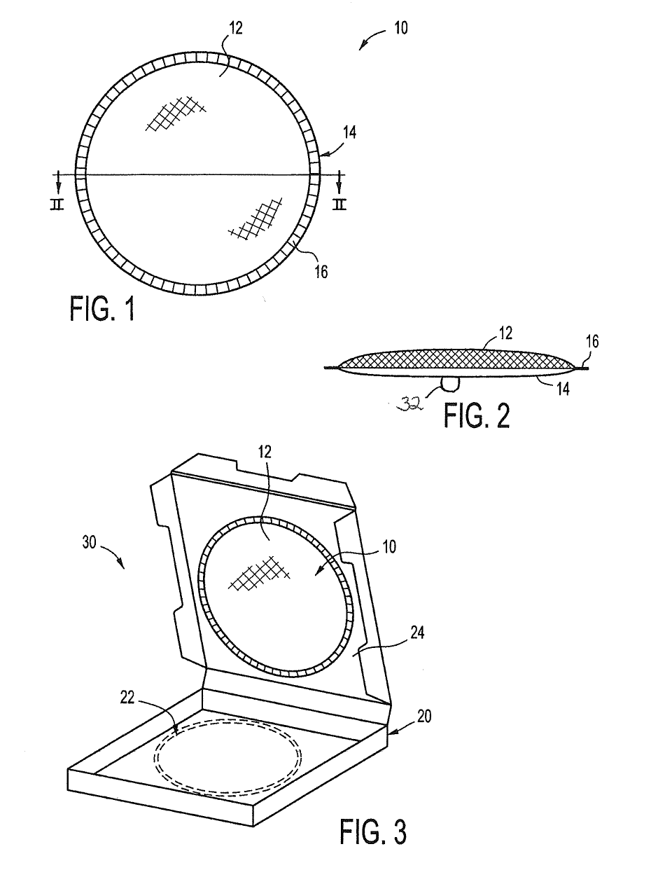

FIG. 1 is a pizza-blotting embodiment 10 of the composite material having an absorbent layer 12 joined to a non-absorbent layer 14. As illustrated, the composite 10 has a perimeter edge 16, which results from the joining of the absorbent layer 12, and the non-absorbent layer 14. The layers 12, 14 may be joined by any suitable means, including, but not limited to, and adhesive, film lamination, seaming, embossing, quilting, and surface bonding. In embodiments with lamination, a degradable lamination may be applied to at least one surface of the absorbent layer, non absorbent layer, or both. The lamination layer may be placed between the absorbent layer and non absorbent layer or added to an exterior surface of the absorbent layer or non absorbent layer. The composite 10 is dimensioned to cover a substantial portion of a surface of a pizza or other take out food and, accordingly, may be provided in a number of different sizes to accommodate foods of different sizes.

The absorbent layer 12 may be made of any suitable material that is capable of absorbing oil or grease in significant quantities. Such materials include, but are not limited to, bi-component micro-fibers, biodegradable fibers, bleached fibers, cellulosic fibers, sulphite bleached fibers, and kraft bleached fibers. The material of the absorbent layer 12 may include materials that are oleophilic, meaning that they have an affinity for oils and grease but not water. The absorbent layer 12 is FDA approved for food contact applications including manufacturing, packaging, processing, preparing, treating, cooking, packing, transporting, or holding foods. The layer is low-linting, such that absorbent layer 12 does not leave lint on the food (e.g. pizza) after contact.

Inn one example, the absorbent layer 12 is a grade of crepe paper comprising a textured surface. The absorbent layer further is a 99% biobased material that is fluorine free, non-biotoxic, and safe for food contact applications. The surface of the absorbent layer is textured to absorb and trap liquid. In one example, the textured surface includes ridges and valleys. The ridges provide a capillary force for wicking liquid from food surfaces and the valleys trap absorbed liquid the absorbent layer and in a system of pockets between the absorbent layer and a lamination layer.

The paper material comprising the absorbent layer further meets the 99% biodegradable composition requirement of the ASTM D6868-11 compostability standard. The absorbent layer may comprise one or many sheets of 5 lbs to 55 lbs basis weight paper having a thickness of 1.0 mils to 7.0 mils and a Sheffield porosity of 150 to 300 units. The absorbent layer further has an auto ignition temperature greater than 400° F. and a moisture percentage between 5.0% and 7.5%. The low moisture percentage minimizes paper curl and the ignition temperature above 400° F. allows the material to be used in high temperature cooking applications.

The non-absorbent layer 14 (seen in FIG. 2) may be made of any suitable non-absorbent material that is not permeable by oils or grease. Such materials include oil and grease resistant papers (OGR), oleophobic fiber webs, polymeric films, and liquid barrier coatings. Advantageously, when the non-absorbent layer 14 is made of a flexible OGR paper, the composite 10 may have a desirable degree of malleability, such that the composite may be crumpled after use for convenient disposal without the user having to contact the oil-soaked absorbent layer 12.

In one example, the non-absorbent layer is and oil and grease resistant (OGR) material having a kit level between 2 and 9. The non-absorbent layer is further fluorine free, non-biotoxic, and safe for food contact applications. The non-absorbent layer has a flash point above 400° F. and repels fats, oil, and grease (FOG), water, and other liquids.

In a composite material, the non-absorbent layer is laminated to at least one surface of the absorbent layer to form a liquid barrier between the absorbent layer in contact with a food surface and the non-absorbent layer in contact with an external surface including a cooking surface, a customer holding food, or a recyclable material such as corrugated cardboard. The liquid barrier may repel water, polar liquids, oil, grease, organic liquids, and mixtures thereof. The liquid barrier allows a first portion of the composite material to absorb and trap liquid and a second portion to prevent liquid from seeping through the first portion.

In a preferred example, the the non-absorbent layer is a compostable OGR paper material having over 90% biobased content paper. The non-absorbent layer meets the 99% biodegradable composition requirement of the ASTM D6868-11 compostability standard and contains no petroleum based polymers. In an another example, the non-absorbent layer is a liquid barrier coated material that repels OGR, water, and other liquids. The non-absorbent layer contains petroleum based polymer materials including, high density polyethylene (HDPE), low density polyethylene (LDPE), linear low density polyethylene (LLDPE), ultra low density polyethylene (ULDPE), polyhydroxyalkanoate (PHA), polyglycolic acid (PGA), polyethylene terephthalate (PET), polypropylene (PP), polystyrene, and polyvinyl chloride (PVC).

The lamination layer 18, joins the absorbent layer 12 to the non-absorbent 14 layer. The lamination layer provides a liquid barrier between the absorbent layer and the nonabsorbent or aberrant layers. The lamination layer comprises a non-biotoxic water based polymer emulsion coating with a flash point greater than 400° F. The lamination layer is applied as a surface coating to at least one of the absorbent layer or non-absorbent layer. In this example, the lamination layer forms a second liquid barrier between the absorbent layer and the non-absorbent layer. The additional liquid barrier enhances the composite material's ability to trap liquids in the absorbent layer by creating a system of pockets between the absorbent layer and the lamination layer. The composite material stores liquid in the pockets to prevent absorbed liquids from seeping through top layers of the composite material into the non-absorbent layer.

By bonding to the ridges on the surface of the absorbent layer, the lamination layer forms a seal over the space between the valleys and ridges on the lamination layer. This seal creates a network of pockets for holding absorbed liquid between the absorbent layer and the lamination layer. The liquid barrier prevents pooling by compressing liquid into the pockets between the sealed top surface of the ridges and the bottom surface of valleys in the absorbent layer. Additionally, by compressing absorbed liquid in the pockets, the liquid barrier formed by the lamination layer creates a wicking effect that draws absorbed liquids across the surface of the absorbent layer to unsaturated areas. The lamination layer allows the composite material of this invention to trap liquid in the absorbent layer better than conventional materials because it forms a second liquid barrier that prevents saturation and pooling in the absorbent layer and enhances the OGR properties of the non-absorbent layer.

Typical oil and grease and aqueous barrier coatings often use specialty petroleum based polymer(s), wax, and/or higher polymer binder level compared to conventional print and binder coatings. Such coatings contaminate recycling streams by rendering otherwise recyclable materials are not recyclable because of problems with repulping coated paper material. Complex, sticky polymer coatings are difficult to breakdown in conventional acidic pulping process. When in a strongly acidic environment, for example, in a solution with a pH lower than 2, the coatings tend to clump and form “stickies”, and other particles are larger than the acceptable size for paper making from recycled materials.

Conventional coatings comprising petroleum based polymers similarity contaminate composting streams because they do not readily disintegrate in industrial scale composting processes. The high content specialty polymers, for example, petroleum based polymer binder makes it is extremely challenging for conventional coatings and coated paper materials to meet the >1% non-biodegradable composition requirement for the ASTM D6868-11 compostability standard.

“Blocking” is another problem associated with paper materials coated with conventional coatings. Blocking occurs when layers of coated paper material stick together either in the real or after being rewound into rolls. More particularly, blocking in the reel is especially problematic when residual heat from the dryers dissipates slowly because of the large mass of the reel. Higher temperatures resulting from residual heat on the reel in turn can cause conventional coatings to stick or even melt as a result of thermal instability.

The lamination layer described herein improves upon conventional liquid barrier coatings because it is non-blocking, recyclable, and compostable. The lamination material is made out of non-biotoxic materials that are safe for food contact applications and meet the >99% biodegradable composition requirement of the ASTM D6868-11 standard. When placed between an absorbent crepe paper and a non absorbent OGR paper the lamination layer causes absorbed oils to wick across the surface of the absorbent layer. This wicking effect is produced by applying an impermeable, semi-permeable, or oleophilic lamination layer to an absorbent layer with an uneven surface. In one example, the absorbent layer is a crepe paper with ridges, valleys, and other small structures proliferating from—and protruding into—the paper's surface to help wick absorbed liquid into the main portion of the paper.

When applied to a surface of the non-absorbent layer, the lamination layer adheres to the structures proliferating from the surface of the absorbent crepe paper, thereby leaving gaps between ridges and other small structures on the surface of absorbent layer and the valleys protruding into the main portion of the paper. As liquids are absorbed by the absorbent layer, the liquid barrier formed by the lamination layer compresses the oils against the main portion of the absorbent layer and the lamination layer. This compression force drives the absorbed oil across the surface of the absorbent crepe in order to avoid pooling and seepage. By distributing oil more evenly across a greater portion of a food package, the composite material prevents absorbed oils from spoiling the reusability of food packaging while also making greasy foods healthier and less messy by removing fat, oil, grease, cholesterol, sodium, and other high calorie nutrients.

The lamination layer may further contain a binding agent that increases the lamination strength of the lamination layer. Increasing the layer's lamination strength causes the laminated surface of the non-absorbent layer to better adhere to the absorbent layer. In one example, applying the lamination layer to the absorbent layer and waiting a period of one to five seconds before joining the non-absorbent layer, improves the thermal degradation properties of the composite material. This method of combining the layers into a composite gives the lamination layer time to fill in the valleys on the surface of the absorbent layer, thereby creating a uniform surface to join the non-absorbent layer. Pressing the non-absorbent layer to a smooth surface of lamination layer fortifies the bond between the layers of the composite thereby increasing the flash point of the composite and minimizing paper curl. The lamination layer may also be applied as a print coating or can otherwise serve as a substraint for ink printing.

In an exemplary embodiment, the absorbent layer 12 is a crepe paper comprising cellulosic fibers and the non-absorbent layer 14 is an OGR paper. More specifically, in one embodiment the absorbent layer 12 is a crepe paper made of four to six layers of cellulose wadding having a basis weight of 12 to 18 pounds. The material may be virgin material that is biodegradable and recyclable. The sheets of wadding may be “pinned” together initially in an embossing type process to form a friction connection that creates a self-supporting sheet of absorbent material. An example of such absorbent material is the cellulose sheeting sold by Pregis Corporation under the trademark “Cushion Pack”.

As described, the absorbent layer 12 is backed by the non-absorbent layer 14 and optionally coated by a lamination layer. The non-absorbent layer 14 may be a OGR paper or polymeric film, such as polyethylene, that is glued, attached by a lamination film, or otherwise affixed to the absorbent layer to form the composite 10. In one embodiment, the non-absorbent layer is laminated 10 to provide additional oil and grease resistance.

The sustainable composite paper may also disintegrate naturally and be biodegradable, non-toxic, and compostable under American Society for Testing and Materials (ASTM) or Biodegradable Products Institute (BPI) standards, for example the ASTM D6400 testing criteria for plastic and the ASTM D6868 testing criteria for coated paper products.

In use, the composite 10 is placed against a pizza or other food item from which oil or grease is to be blotted with the absorbent layer 12 in contact with the food item. The composite 10 may contact either an upper or lower surface of the food, as desired, to extract oil or grease without adversely affecting the food. In the case of pizza, which is commonly placed in a box for transportation, this leads to at least the following two potential positions of the composite 10 relative to the box.

FIG. 3 illustrates a pizza box assembly 30 that includes a pizza box 20 and the pizza-blotting composite 10 shown in FIGS. 1 and 2. The pizza box 20 is a standard collapsible box used commonly in the industry, having an inner cavity or receptacle 22 for holding the pizza and a top 24 of the box 20, such that the absorbent layer 12 faces the inner receptacle 22. The composite 10 may be attached to the interior top 24 of the box 20 by any suitable means, including adhesives. In one aspect, the composite 10 may be removed after use and the pizza box 20 may be recycled.

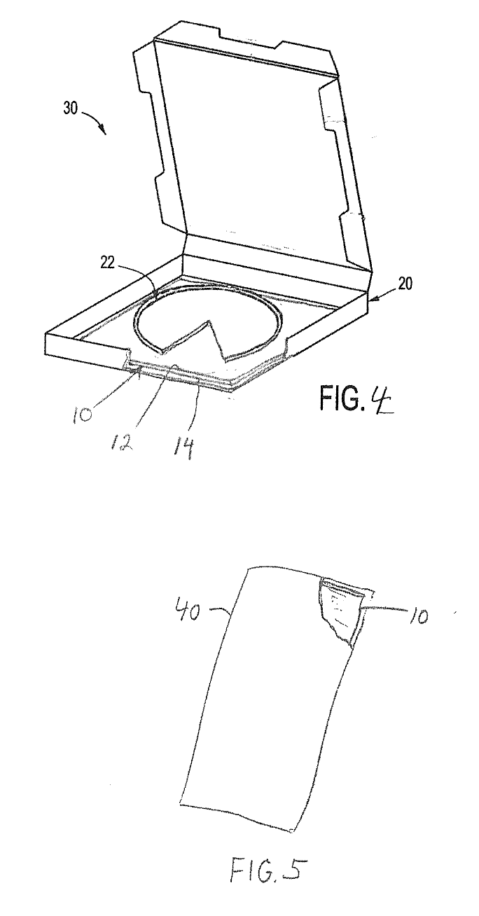

FIG. 4 illustrates an alternative arrangement of the composite 10 relative to the pizza box, wherein the composite is located within the inner receptacle 22 of the pizza box at a location beneath the pizza. When the pizza in the box is cut or “scored” oil and grease from the pizza is efficiently wicked to the underside by the absorbent layer 12 without disturbing the upper surface of the pizza as can occur when its upper surface is blotted. Therefore, the arrangement of FIG. 4 operates advantageously in a surprisingly efficient manner to extract undesired oil and grease.

When the composite 10 is used beneath the pizza in the configuration of FIG. 4, the pizza may be cut prior to or after being placed on the composite. Due to the durable nature of the composite, it is not normally severed when a rolling cutter is used on the pizza.

Placement of the composite beneath the pizza enables excess oil and grease to pass downwardly to the composite for efficient absorption by the absorbent layer 12. The oil and grease cannot pass beneath the composite 10, however, because the non-absorbent layer 14 acts as a barrier. The bottom of the pizza box 20 therefore remains oil and grease-free, enabling it to be recycled.

As illustrated in FIG. 4, the composite 10 may be square or any other suitable shape to cover the bottom of the pizza box. Particularly when the composite is placed beneath a pizza or other food item, it may be desirable to cover the entire bottom of the container in which the food item is placed. Alternatively, the composite 10 placed beneath a pizza may be circular and dimensioned to match the outline of the pizza.

In other instances, such as when pizza or other food items are consumed on the premises of a restaurant, the composite can still be used under the food to absorb the oil and grease. In any case, once the pizza is finished, the composite may be folded inwardly onto itself without touching the grease-saturated absorbent layer 12 by grasping the non-absorbent layer 14.

When the composite 10 is used to blot a pizza or other food item from above, the non-absorbent layer 14 may have a flexible tab, string, or other physical feature 32 enabling the user to lift the composite away from the food without touching the saturated absorbent layer 12. The weight of the absorbed oil and grease then causes the composite 10 to hang downwardly with the grease-impermeable non-absorbent layer 14 on the outside, facilitating disposal of the composite without getting oil or grease on the user's hands.

When the non-absorbent layer 14 is metallic, the composite 10 also serves an additional purpose of retaining heat within the pizza by reflection in either an up or down direction, depending on the position of the composite.

In another form, separate pieces of the composite 10 may be provided above and below a pizza with the absorbent layer 12 facing and in contact with the surfaces of the pizza to absorb oil and grease from both the top and the bottom of the pizza. Alternatively, the top and bottom layers of the composite 10 may comprise a single sheet of the composite that extends underneath the pizza and is folded over to also engage the top of the pizza to absorb oil and grease from the top and bottom of the pizza simultaneously.

The foldable nature of the composite 10 enables it to be packaged in a compact and inexpensive package 40 which may be in the form of a sealed plastic, paper or foil-backed pouch, as illustrated in FIG. 5. In this form, the composite is suitable for distribution with a take-out pizza or other food item for convenient use by the consumer in extracting oil and grease from the food item. In situations where a composite 10 is provided above or below a pizza in the box of FIG. 3 or FIG. 4, another composite 10 might also be provided for manual use by the consumer to further reduce the quantity of oil and/or grease consumed.

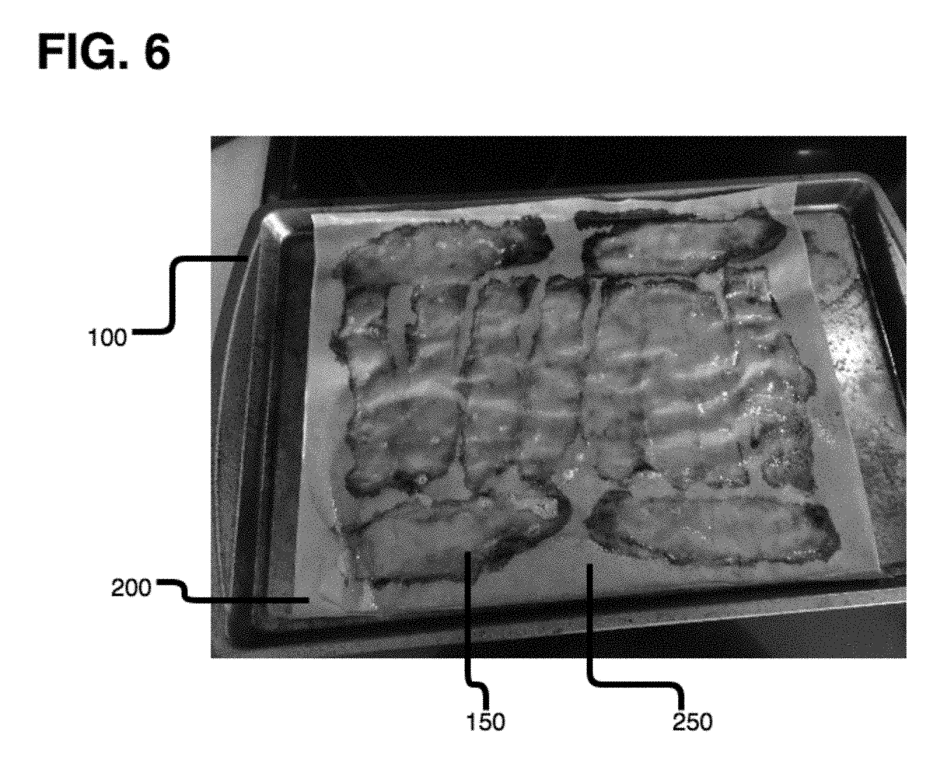

FIG. 6 is a picture of a baking sheet 100 that was used to cook bacon at 450° F. As shown, the baking sheet 100 is fitted with a liner comprising the composite material 200. The dark colored areas 150 on the surface of the composite material 200 illustrate the oil and grease consumed by the material during and after cooking the bacon. The light colored areas 250 correspond to portions of the composite material that are not saturated with absorbed grease.

### Characterization

Samples of the embodiments described herein were tested for compostability and absorbance. The chemical composition of the sample embodiments was also discerned to evaluate the material's safety for food contact applications. Compostability tests were performed according to the American Society for Testing and Material (ASTM) International test for standard specification for labeling of end items that incorporate plastics and polymers as coatings or additives with paper and other substrates designed to be aerobically composted in municipal or industrial facilities or the ASTM 6868. Tests were performed under laboratory conditions at the University of Wisconsin-Stevens Point Institute for Sustainable Technology in Stevens Point, Wis.

The ASTM 6868 is a set of testing criteria used by the Biodegradable Products Institute (BPI) to certify compostable materials and products such as food packaging. BPI relies on the ASTM D6400 test for plastic and the ASTM 6868 test for coated paper products or paper materials polymer binding agents. To pass ASTM tests and become part of BPI's certified compostable program, a product must: i) disintegrate quickly leaving no visible residue that has to be screened out, ii) biodegrade fully or convert rapidly to carbon dioxide water and biomass, iii) result in compost that supports plant growth, and iv) not introduce high levels of regulated materials into the soil.

The ability of samples to absorb fat, calories, cholesterol, fatty acids, and sodium from the surface of cooked take-out pizzas was tested using pizzas obtained from PIZZA HUT, DOMINO's, PAPAJOHN's, LITTLE CAESARS, and SABARRO. Pizzas contacting samples included thin crust pizzas, thick crust pizzas, meat lovers pizzas, and veggie pizzas. Testing was performed under laboratory conditions by COVANCE LABORATORIES, INC. of Madison, Wis.

### Compostability

Disintegration and biodegradation methodology for this experiment was based on a modified version of the ASTM method for compostability tested without humidified aeration and carbon dioxide capture (ASTM D5338). Industrial composition conditions were simulated in a laboratory incubator set to 58° C.±20 for 7 weeks in the Wisconsin Institute for Sustainable Technology Compostability Laboratory at the University of Wisconsin Stevens Point College of Natural Resources. The composting vessels were 2-liter KIMAX glass bottles closed at the top by a rubber stopper fitted with a hole running through the center. An air-tight rubber sleeve was fitted around the threaded mouth of the bottles to avoid sticky glass on rubber contacts between the bottle and stopper. A plastic tube was inserted through the stopper hole into the glass bottle to limit moisture loss while providing for controlled gas exchange during composting.

There were two treatments tested in this example: a paper composite material and untreated cellulose paper. A negative blank of mature compost was also tested as a control. The untreated cellulose paper and paper composite material were added to compost in a 6:1 or 16% paper to dry compost ratio. Each treatment and the control were replicated seven times with each vessel comprising a complete, distinct sampling unit. There were twenty one vessels at the beginning of the experiment, with three sampling units removed at the end of weeks 1, 2, 3, 4, 5, 6, and 7. The vessels were placed in the incubator in a complete randomized design.

The compost in this experience is municipal, deciduous left compost (mature 2-4 months) sourced from Hsu's Compost and Soils in Wausau, Wis. Hsu's leaf compost is certified through the United States Composting Council (USCC) according to the Seal of Testing Assurance (STA) program. The compost was composed of tree leaves from municipal collection in the Wausau and Appleton, Wis. areas. Each 2-liter vessel required required 615 g of as-received (moist) compost. The compost was sieved using an 8 mm sieve to remove large debris, which was then discarded. Mature compost was used based upon the D5338 method for coated paper disintegration.

The paper composite material was prepared using an absorbent crepe paper and a non-perfluorooctanoic acid (PFOA), non-perfluorooctane sulfuric acid (PFOO), non-perfluorinated carboxylic acid (PFCA), and non-perchlorate OGR paper from Expera Specialty Solutions in Moisinee, Wis. The papers laminated together using a non-hazardous water based polymer emulsion laminate supplied from—and applied by—Prolamina Flexible Packaging Solutions, a division of Proampac, in Neenah, Wis. The untreated cellulose paper was also obtained from Expera Specialty Solutions.

The paper treatments were incorporated into the compost by cutting the paper and paper composite material, by hand, into 2 cm×2 cm squares according to the ASTM D5338. The squares were then weighted in a beaker to discern the number of squares added to each vessel to achieve the desired 6:1 (615 g: 98.4 g) compost to paper ratio. Compost (615 g) was weighed into each of the twenty one vessels and the pre-weighted paper was added. Distilled water was added to bring the entire compost and paper matrix up to 60%±2% moisture content. Between 101 mL and 110 mL of distilled water was added to each vessel and moisture content of the initial compost was determined gravimetrically by weighing samples from each vessel and drying for 48 hours in a 105° C. oven. The compost, paper, and water were mixed thoroughly using 2-pronged forks until a uniform matrix was produced. Each vessel was labeled with the week of its removal, the treatment, and the paper addition.

Each week during the 7 week active composting period, the compost vessels were removed from the incubator and weighed. Moisture was maintained between 50% and 60% through the 7 week trial. Moisture additions were based on individual jar weight loss and visual observations of compost and paper structure. Moisture additions were made by adding distilled water to individual vessels based on weight and additional water was mixed in using a flat soil knife. Hand mixing was necessary to promote aeration and consistent moisture distribution through the compost matrix. Mixing occurred twice a week, once with moisture additions and once without.

During final sampling of vessels removed at various weeks, the paper was separated from the compost using a series of 3 brass sieves (8 mm, 4 mm, and 2 mm) and picked from the compost using tweezers. Paper too large to pass through the 2 mm sieve was weighted (including residual compost). Paper was further processed by washing with de-ionized water over a 2 mm sieve. With much of the residual compost removed, the paper was dried in an oven at 60° C. for 6 hours. Final paper mass was recorded once dry. Paper and compost, per vessel, from removed vessels, were stored separately in quart sized ZIPLOC freezer bags. The remaining vessels were returned to the incubator in a re-randomized order. Samples from removed vessels were frozen and stored in a 0° C. walk-in freezer.

Results of the compostability testing are shown below in Table 1.

TABLE 1

| | Start | Final | % Breakdown |
|---|---|---|---|
| Material | Weight | Weight | Theoretical Carbon |
| Composite Material | 98.4 g | 19.1 g | 80.6 |
| Untreated Cellulose Paper | 98.4 g | 19.9 g | 79.8 |

After 5 weeks, the composite paper material and the untreated cellulose paper were both ahead of the 90% breakdown benchmark (72% breakdown). After 12 weeks, the % breakdown theoretical carbon of the composite material was over the ASTM D6868 90% benchmark for biodegradation and more than 90% of the original material was lost to disintegration.

FIG. 6 illustrates the % breakdown of the composite material and the untreated cellulose paper over the first 5 weeks of the compostability testing. As shown in the figure, after 10 days, the composite material was in-line with or exceeded the 90% breakdown benchmark. Furthermore, after 35 days, the composite material out performed both the 90% benchmark (by 8.6%) and the untreated cellulose paper (0.8%) in biodegradation and disintegration.

### Nutrient Absorbance

The composite material was evaluated for its ability to absorb excess nutrients from the surface of greasy takeout foods. Pads made from the composite material were placed in contact with pizzas obtained from five popular take out pizza chains-PIZZA HUT, DOMINO's, PAPAJOHN's, LITTLE CAESARS, and SABARRO in Madison, Wis. Pads weight ranged from 11.8 g to 7.3 g so that pads of various sizes could be evaluated for there ability to absorb nutrients from different types of take out pizza. Thin crust, thick crust, “meat lovers”, and veggie style pizzas were tested. Absorbance experiments were performed by Covance Laboratories, Inc. of Madison, Wis. Samples very prepared in the field in a mobile laboratory and nutrient extraction was performed under laboratory conditions using the Soxhlet extraction method.

Samples were prepared by applying pads to the top and bottom surfaces of the pizzas. Once in contact with the pizza, the composite material absorbed nutrients from the pizza surface into into the pads. Soaked pads were stored on ice and transported to Covance Laboratories for nutrient extraction and absorbance analysis.

Nutrients were absorbed form the pizzas using this method: i) weigh composite paper material pad before use, ii) obtain a take out pizza in corrugated cardboard pizza box from a take out restaurant, iii) within 5 minutes of purchasing the pizza, insert the pad underneath the bottom surface of the pizza so that the pad is between the pizza surface and the cardboard box, iv) close the pizza box and weight 30 minutes, v) apply a second pad to the top surface of the pizza by pressing down lightly to assure contact between the pizza and the composite material, vi) remove both pads after 2 minutes of contact by the second pad, vii) remove any loose toppings of pizza material from the pads, and viii) weigh each pad separately immediately after use.

Nutrients were extracted from prepared samples using the Soxhlet extraction method. The extraction was conducted under laboratory conditions using the extraction method described in Official Methods of Analysis of AOAC INTERNATIONAL, Method 960.39 and 948.22 published by AOAC INTERNATIONAL of Gathersburg, Md. Excess nutrients were extracted from pads made from paper composite material by: i) obtain pads applied to take food in the field, ii) weigh pads into a cellulose thimble containing sea sand and dried to remove excess moisture, iii) extract nutrients from pads using pentene as a solvent for 5 hours, iv) evaporate pentene from the extract, v) dry and weigh the extract for analysis.

Upon extraction, the composition of extracted nutrients was determined by Inductively coupled plasma atomic emission spectroscopy (ICP-AES). This technique produces an inductively coupled plasma to excite atoms into emitting a electromagnetic radiation response that is characteristic of a particular element or combination of elements. Measured sodium and fat content of the extract absorbed by the composite paper material pads was then used to calculate the fat and sodium content of the nutrients absorbed by the pad from the pizzas. The percent of the pizza's total sodium and fat content absorbed by the composite material was determined using the nutrient content analysis to provide an estimate for the paper composite materials ability to remove fat and sodium from take out foods.

Results of the fat absorbance analysis including are displayed below in Table 2.

TABLE 2

| | Absorbed | Absorbed | Absorbed | % Fat |
|---|---|---|---|---|
| Sample | Nutrients | Fat | Calories | Reduction |
| Pad 1 | 11.80 g | 10.49 g | 94.4 Cal | 9.5% |
| Pad 2 | 9.60 g | 9.09 g | 81.8 Cal | 8.8% |
| Pad 3 | 9.10 g | 8.12 g | 73.1 Cal | 7.4% |
| Pad 4 | 10.60 g | 7.97 g | 71.8 Cal | 6.1% |
| Pad 5 | 11.10 g | 9.42 g | 84.8 Cal | 8.1% |
| Pad 6 | 8.60 g | 6.88 g | 61.9 Cal | 5.6% |
| Pad 7 | 8.60 g | 6.48 g | 58.3 Cal | 5.0% |
| Pad 8 | 9.60 g | 8.70 g | 78.3 Cal | 8.0% |
| Pad 9 | 7.30 g | 6.77 g | 60.9 Cal | 6.4% |
| Pad 10 | 8.90 g | 8.29 g | 74.6 Cal | 7.9% |
| Average | 9.52 g | 8.22 g | 69.2 Cal | 7.3% |

Fat in this analysis includes saturated fatty acids, monounsaturated fatty acids, polyunsaturated fatty acids, and trans fatty acids. The fatty acids measured in this analysis include, Butyric Acid, Caproic Acid, Caprylic Acid, Capic Acid, Lauric Acid, Myristic Acid, Myristoleic Acid, Pentadecanoic Acid, Pentadecenoic Acid, Palmitic Acid, Heptadecanoic Acid, Heptadecenoic Acid, Stearic Acid, Oleic Acid, Linoleic Acid, Arachidic Acid, Gamma Linolenic Acid, Eicosadienoic Acid, Behenic Acid, Erucic Acid, Eicosatrienoic Acid, Arachidonic Acid, Arachidonic Acid, and Lignoceric Acid. On average, 86.5% of all Absorbed Nutrients were Fat leaving only 13.5% for sodium, cholesterol, an other nutrients. % Total Fat was calculated assuming a pizza with 98 g fat per serving.

Results of the sodium absorbance analysis are shown below in Table 3.

TABLE 3

| | Absorbed | | Absorbed | % Sodium | % Daily |
|---|---|---|---|---|---|
| Sample | Nutrients | % Sodium | Sodium | Reduction | Value |
| Pad 11 | 10.2 g | 0.56% | 57.6 mg | 1.0% | 1.6% |
| Pad 12 | 15.6 g | 0.10% | 15.3 mg | 0.27% | 0.64% |
| Pad 13 | 34.6 g | 0.07% | 25.5 mg | 0.45% | 1.06% |
| Average | 21.0 g | 0.24% | 32.8 mg | 0.57% | 1.1% |

Sodium measured in this analysis includes chloride and sodium chloride salt. % Sodium Reduction was based on a total sodium value of 5,610 mg per serving and % Daily Value was calculated using a 3,400 mg sodium daily value.

### Thermal Insulation

The composite material was evaluated for its ability to thermally insulate food. Specifically, the material's tendency to reduce heat loss from cooked food while inside conventional food packaging was evaluated relative to a control sample. Temperature data was gathered on large pizzas obtained from five popular take out pizza chains-PIZZA HUT, DOMINO's, PAPAJOHN's, LITTLE CAESARS, and SABARRO in Madison, Wis. In order to isolate the thermal insulation character of the composite material, pizzas were kept in corrugated cardboard boxes throughout the experiment for both the control samples and the samples containing the composite material. Thermal insulation experiments were performed by COVANCE LABORATORIES, INC. of Madison, Wis. Samples were prepared and temperature data was collected in the field in a mobile laboratory using an infrared thermometer.

Samples containing the composite material were prepared by placing a first pad composed of the composite paper material under the pizza and a second pad over the top surface of the pizza 10 minutes after obtaining the pizza. Temperature measurements were made for the control samples 5 minutes after receiving the pizza and 30 minutes after receiving the pizza. The total time for the control experiment was 25 minutes. For the composite material samples, temperature measurements were made 5 minutes after obtaining the pizza (5 minutes before placing the sheet) and 30 minutes after applying the pads to the pizza. The total time for the composite material experiment was 35 minutes. To obtain the thermal insulation property, the initial temperature of the pizza was subtracted from the final temperature of the pizza. Each experiment was repeated seven times to collect data across multiple trials.

Results of the thermal insulation experiments for the control samples are displayed below in Table 4.

TABLE 4

| Sample | Initial Temperature | Final Temperature | Temp. Difference |
|---|---|---|---|
| Control 1 | 58.9° C. | 47.9° C. | 11.0° C. |
| Control 2 | 69.0° C. | 58.8° C. | 10.2° C. |
| Control 3 | 69.9° C. | 61.7° C. | 8.2° C. |
| Control 4 | 75.6° C. | 63.2° C. | 12.4° C. |
| Control 5 | 69.3° C. | 59.2° C. | 10.1° C. |
| Control 6 | 70.4° C. | 54.2° C. | 16.2° C. |
| Control 7 | 69.5° C. | 46.2° C. | 23.3° C. |
| Average | 68.9° C. | 55.9° C. | 13.1° C. |

Results of the thermal insulation experiment for the composite material samples are displayed below in Table 5

TABLE 5

| Sample | Initial Temperature | Final Temperature | Temp. Difference |
|---|---|---|---|
| Pad 1 | 61.6° C. | 54.4° C. | 7.2° C. |
| Pad 2 | 59.0° C. | 54.4° C. | 4.6° C. |
| Pad 3 | 66.1° C. | 59.5° C. | 6.6° C. |
| Pad 4 | 64.4° C. | 53.1° C. | 11.3° C. |
| Pad 5 | 67.2° C. | 53.8° C. | 13.4° C. |
| Pad 6 | 66.1° C. | 54.4° C. | 11.7° C. |
| Pad 7 | 66.4° C. | 47.3° C. | 19.1° C. |
| Average | 64.4° C. | 53.8° C. | 10.6° C. |

The preceding discussion merely illustrates the principles of the present pizza-blotting composites and pizza box assemblies containing such pizza-blotting composites. It will thus be appreciated that those skilled in the art may be able to devise various arrangements, which, although not explicitly described or shown herein, embody the principles of the inventions and are included within their spirit and scope. Furthermore, all examples and conditional language recited herein are principally and expressly intended to be for educational purposes and to aid the reader in understanding the principles of the invention and the concepts contributed by the inventor to furthering the art and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Terms such as “upper”, “top”, and “lower” are intended only to aid in the reader's understanding of the drawings and are not to be construed as limiting the invention being described to any particular orientation or configuration.

This description of the exemplary embodiments is intended to be read in connection with the figures of the accompanying drawings, which are to be considered part of the entire description of the invention. The foregoing description provides a teaching of the subject matter of the appended claims, including the best mode known at the time of filing, but is in no way intended to preclude foreseeable variations contemplated by those of skill in the art.

We claim:

1. A method of preparing high fat content food that minimizes water consumption comprising:
obtaining a composite material comprising an absorbent layer configured to absorb liquid from a food surface and a non-absorbent layer configured to prevent absorbed liquid from traveling through the composite material to and external surface;
cooking food at high heat by placing the food on a piece of cookware then placing the cookware in an oven;
before cooking, covering the cookware with the composite paper material so that the composite paper material is positioned between the top surface of the cookware and the bottom surface of the food;
after cooking, removing the cookware from the oven;
keeping the food on the cookware for a period of at least five minutes before serving to allow the food to cool and give the composite material addition time to absorb liquids from the food surface;
removing the food and the composite material from the cookware;
disposing the composite material; and
re-using the composite material without washing it,
wherein, a third party organization certifies kitchens using the composite material to cover the cookware during cooking may avoid washing the cookware before reuse.

2. The method of claim 1, wherein high fat content food is any food containing meat, cheese, and other high fat content ingredients including butter, oil, and shortening.

3. The method of claim 1, wherein liquid is selected from the group consisting of water and other polar liquids, oil, grease, fat and other organic liquids, and mixtures thereof

4. The method of claim 1, wherein the composite material further comprises a lamination layer applied to at least one surface of the absorbent layer, the lamination layer joins the absorbent layer to the non-absorbent layer to create a second liquid barrier between the absorbent layer and the non-absorbent layer.

5. The method of claim 1, wherein the composite material meets the 99% biodegradable composition requirement of the ASTM D6868-11 standard.

6. The method of claim 1, wherein external surface is selected from the group consisting of a cooking surface, a customer holding food, or a recyclable material surface.

7. The method of claim 1, wherein the third party organization is a state or federal Environmental Protection Agency.

8. A method of preparing high fat content food that minimizes water consumption comprising:
obtaining a composite material comprising an absorbent layer configured to absorb liquid from a food surface and a non-absorbent layer configured to prevent absorbed liquid from traveling through the composite material to and external surface;
cooking food at high heat by placing the food on a piece of cookware then placing the cookware in an oven;
before cooking, covering the cookware with the composite paper material so that the composite paper material is positioned between the top surface of the cookware and the bottom surface of the food;
after cooking, removing the cookware from the oven;
keeping the food on the cookware for a period of at least five minutes before serving to allow the food to cool and give the composite material addition time to absorb liquids from the food surface;
removing the food and the composite material from the cookware;
disposing the composite material; and
re-using the composite material without washing it,
wherein, a third party organization certifies using the composite material to cover the cookware during cooking reduces water consumption.

9. The method of claim 8, wherein high fat content food is any food containing meat, cheese, and other high fat content ingredients including butter, oil, and shortening.

10. The method of claim 8, wherein the composite material further comprises a lamination layer applied to at least one surface of the absorbent layer, the lamination layer joins the absorbent layer to the non-absorbent layer to create a second liquid barrier between the absorbent layer and the non-absorbent layer.

11. The method of claim 8, wherein the composite material meets the 99% biodegradable composition requirement of the ASTM D6868-11 standard.

12. The method of claim 8, wherein external surface is selected from the group consisting of a cooking surface, a customer holding food, or a recyclable material surface.

13. The method of claim 1, wherein the third party organization is a state or federal Environmental Protection Agency.

14. A method of preparing high fat content food that minimizes water consumption comprising:
obtaining a composite material comprising an absorbent layer configured to absorb liquid from a food surface and a non-absorbent layer configured to prevent absorbed liquid from traveling through the composite material to and external surface;
cooking food at high heat by placing the food on a piece of cookware then placing the cookware in an oven;
before cooking, covering the cookware with the composite paper material so that the composite paper material is positioned between the top surface of the cookware and the bottom surface of the food;
after cooking, removing the cookware from the oven;
keeping the food on the cookware for a period of at least five minutes before serving to allow the food to cool and give the composite material addition time to absorb liquids from the food surface;
removing the food and the composite material from the cookware;
disposing the composite material; and
re-using the composite material without washing it,
wherein, a third party organization certifies using the composite material to cover the cookware during cooking reduces the amount of chemical and food waste discharge from commercial kitchens.

15. The method of claim 14, wherein high fat content food is any food containing meat, cheese, and other high fat content ingredients including butter, oil, and shortening.

16. The method of claim 14, wherein the composite material further comprises a lamination layer applied to at least one surface of the absorbent layer, the lamination layer joins the absorbent layer to the non-absorbent layer to create a second liquid barrier between the absorbent layer and the non-absorbent layer.

17. The method of claim 14, wherein the composite material meets the 99% biodegradable composition requirement of the ASTM D6868-11 standard.

18. The method of claim 14, wherein the third party organization is a state or federal Environmental Protection Agency.

19. The method of claim 14, wherein chemical and food waste discharge includes deterrents used to clean cookware and fats, oils, and grease byproducts from food preparation.

20. The method of claim 14, wherein commercial kitchens includes restaurants, hospitals, hotels, grocery stores, school cafeterias, jails, and other large scale cooking operations.
